(19) United States
(12) Patent Application Publication
(10) Pub. No.: US 2025/0196732 A1
(43) Pub. Date: Jun. 19, 2025

(54) CHILD SAFETY SEAT

(71) Applicant: Wonderland Switzerland AG, Steinhausen (CH)

(72) Inventors: Xiaolong MO, Dongguan, Guangdong (CN); Zujian LIU, Dongguan, Guangdong (CN)

(73) Assignee: Wonderland Switzerland AG, Steinhausen (CH)

(21) Appl. No.: 18/843,602

(22) PCT Filed: Mar. 3, 2023
(86) PCT No.: PCT/EP2023/055451

§ 371 Date: Sep. 3, 2024

(30) Foreign Application Priority Data
Mar. 4, 2022 (CN) 202210209225.2

(51) Int. Cl. B60N 2/28

(52) U.S. Cl. CPC B60N 2/2821; B60N 2/2869; B60N 2/2875

(57) ABSTRACT

A child safety seat comprising: a base, comprising a base limit assembly; and a seat, provided above the base and comprising: a mounting base, provided above the base; a seat body, provided above the mounting base, and is movable relative to the mounting base along a pitch adjustment path; and a seat limit assembly, provided on the seat and connected to the seat body; wherein the base limit assembly is engaged with the seat limit assembly to limit longitudinal movement of the seat body.

### CROSS-REFERENCE TO RELATED APPLICATIONS

This application is a National Stage application of PCT/EP2023/055451, entitled “CHILD SAFETY SEAT” and filed on Mar. 3, 2023, which claims the benefit of Chinese Application No. 202210209225.2, filed on Mar. 4, 2022, both of which are incorporated herein by reference in their entirety.

### TECHNICAL FIELD

The present application relates to a child safety seat.

### BACKGROUND

Child safety seats are generally used in vehicles such as cars, which can appropriately limit the displacement of children in case of accidental collision. In consideration of safety and seating comfort, and in order to adapt to children of different sizes, the existing child safety seats are designed to rotatable between the forward direction and reverse direction, and the seat pitch angle can be adjusted. Therefore, the seat needs to be adjustably connected to the base through a rotary mechanism, a slide mechanism and the like.

In this case, when the vehicle collides, the connection mechanism between the seat and the base will bear very large pressure, so it is necessary to provide improvement.

### SUMMARY

A child safety seat according to the present application, including: a base, including a base limit assembly; and a seat, provided above the base and including: a mounting base provided above the base; a seat body provided above the mounting base, and is movable relative to the mounting base along a pitch adjustment path; and a seat limit assembly provided on the seat and connected to the seat body; wherein the base limit assembly is engaged with the seat limit assembly to limit a longitudinal movement of the seat body.

In one embodiment, the mounting base is a rotary seat provided above the base in a manner that the seat is rotatable relative to the base around a substantially vertical axis; wherein the base limit assembly and the seat limit assembly are configured such that when the seat body is rotated to a forward position, the base limit assembly is engaged with the seat limit assembly to limit the longitudinal movement of the seat body in a substantially back-and-forth direction.

In one embodiment, the base limit assembly is provide at a longitudinal rear edge of the base.

In one embodiment, the seat is rotated relative to the base between a forward position and a rearward position, in the forward position, a backrest portion of the seat is close to a rear side of the base, and in the rearward position, the backrest portion of the seat is close to a front side of the base; and the pitch adjustment path includes a substantial back-and-forth movement of a bottom portion of the seat along a longitudinal curve and a substantial up-and-down movement of the backrest portion of the seat along a forwardly inclined vertical curve.

In one embodiment, the seat limit assembly includes: a seat limit assembly vertical portion extending upward from a circumferential edge of the mounting base; a first engagement portion provided at an upper end of the seat limit assembly vertical portion, wherein when the seat body is rotated to a limit angle, the first engagement portion is engaged with the base limit assembly; and a body connection portion connected between the seat body and the seat limit assembly vertical portion.

In one embodiment, the seat limit assembly vertical portions are provided in two and transversely symmetrically provided relative to the seat corresponding to circumferential positions of the backrest portions of the seat, and extend upward along the backrest portion; and the body connection portions are provided in two and respectively connected with corresponding seat limit assembly vertical portions.

In one embodiment, the first engagement portion includes a first engagement hook transversely provided between the two seat limit assembly vertical portions, and the first engagement hook includes a engagement portion which is transversely extended, has a hook-shaped cross section, and is open at both ends in a transverse direction.

In one embodiment, the first engagement hook further includes two bending portions respectively extending forward longitudinally from both ends of the engagement portion in a transverse direction, and a free end of each bending portion is respectively engaged to an upper end of a corresponding seat limit assembly vertical portion.

In one embodiment, the engagement portion has a first vertical wall, a second vertical wall, a bottom wall and an open top side, wherein the bending portion extends forward longitudinally from both ends of the first vertical wall in a transverse direction, the second vertical wall is located behind the first vertical wall, the bottom wall is connected between a bottom side of the first vertical wall and a bottom side of the second vertical wall, and the open top side is opposite to the bottom wall; wherein the engagement portion is engaged with the base limit assembly, such that the second vertical wall is able to abut against the base limit assembly to prevent the seat from moving forward.

In one embodiment, the body connection portion includes a cross bar and a connecting lever, the cross bar is transversely provided between two seat limit assembly vertical portions, the connecting lever extends in a substantively longitudinal direction, and both ends of the connecting lever are pivotally connected to the cross bar and the seat body, respectively.

In one embodiment, the connecting levers are provide in two, an extension hole extending in a same direction as the connecting lever is provided in each connecting lever, the cross bar is provided passing through the extension hole, and pivotally connected with the connecting lever, and the cross bar is moveable in the extension hole relative to the extension hole.

In one embodiment, the first engagement portion includes a hook-shaped portion extending in a hook shape from an upper end of the seat limit assembly vertical portion to engage with the base limit assembly.

In one embodiment, the hook-shaped portion includes a longitudinal extension extending backward from the upper end of the seat limit assembly vertical portion and a vertical extension extending upward from a rear end of the longitudinal extension, and the vertical extension is engaged with to the base limit assembly to limit a forward movement of the seat.

In one embodiment, the hook-shaped portion and the seat limit assembly vertical portion are integrally formed plates; and the seat limit assembly further includes an anti-collision buffer attached to both sides of the hook-shaped portion in a transverse direction and has a substantively same outer contour shape as the hook-shaped portion.

In one embodiment, the body connection portion includes a slide bar and a slide slot component having an elongated slide slot, the slide bar is provided at one of the seat body and the seat limit assembly vertical portion, and the slide slot component is provided at one of the seat body and the seat limit assembly vertical portion; and the slide bar is provided passing through the slide slot component, and the slide bar is moveable in the slide slot component relative to the slide slot component as the seat body is rotated relative to the mounting base along the pitch adjustment path.

In one embodiment, the seat limit assembly is connected to the seat body by the body connection portion; and the first engagement portion and the base limit assembly are engaged with each other such that the first engagement portion and the base limit assembly are moveable relative to each other as the seat body moves relative to the mounting base along the pitch adjustment path.

In one embodiment, the first engagement portion includes a first engagement hook provided between two seat limit assembly vertical portions, and the first engagement hook is transversely extended, has a hook-shaped cross section, and is open at both ends in a transverse direction; and the first engagement hook has a first longitudinal wall, a second longitudinal wall, a rear wall and an open front side, wherein the first longitudinal wall is connected to the seat body, the second longitudinal wall is located above the first longitudinal wall, the rear wall is connected between a rear side of the first longitudinal wall and a rear side of the second longitudinal wall, and the open front side is opposite to the rear wall and faces the seat body; wherein the first engagement hook is moveable relative to the base limit assembly within a travel range, and prevents the seat from moving forward by the rear wall abutting against the base limit assembly.

In one embodiment, the base includes: two strut vertical portions, transversely symmetrically provided relative to the base, and extending upward from a longitudinal rear edge of the base; and a second engagement portion, provided between two strut vertical portions and engaged to the seat limit assembly.

In one embodiment, the second engagement portion includes a second snap hook provided between two strut vertical portions, and the second snap hook is transversely extended, has a hook-shaped cross section, and is open at both ends in a transverse direction.

In one embodiment, the second engagement portion further includes a stiffener transversely provided between the two strut vertical portions; and the second snap hook is a base engagement piece attached to a bottom side of the stiffener.

In one embodiment, the second snap hook includes a third vertical wall and a top wall, wherein the top wall is connected to the strut vertical portion, and third vertical wall extends downward from a front end of the top wall; wherein an engagement between of the third vertical wall and the seat limit assembly prevents the seat from moving forward.

In one embodiment, the second snap hook has a third longitudinal wall, a fourth longitudinal wall and an end wall, wherein the third longitudinal wall is connected to the strut vertical portion, the fourth longitudinal wall is located below the third longitudinal wall, and the end wall is connected between a front side of the third longitudinal wall and a front side of the fourth longitudinal wall; wherein the second snap hook is moveable relative to the seat limit assembly within a travel range, and the fourth longitudinal wall abuts against the seat limit assembly to prevent the seat from moving forward.

In one embodiment, as the seat body moves along the pitch adjustment path, the seat is always engaged with and the base through the seat limit assembly and the base limit assembly, and a relative position between the first engagement portion of the seat limit assembly and the second engagement portion of the base limit assembly is substantively unchanged.

### BRIEF DESCRIPTION OF THE DRAWINGS

The embodiments of the present application will be specifically described below in combination with the accompanying drawings, in which:

FIG. 1 is a perspective view of a child safety seat according to the first embodiment of the present application, wherein the seat and the base are shown in a disengaged state;

FIG. 2 is a perspective view of the child safety seat;

FIG. 3 is a rear view of the child safety seat;

FIG. 4A is a side sectional view of the child safety seat, wherein the seat body is in a supine position, and FIG. 4B is a partial enlarged view of the frame in FIG. 4A;

FIG. 5A is a side sectional view of the child safety seat, wherein the seat body is in an upright position, and FIG. 5B is a partial enlarged view of the frame in FIG. 5A;

FIG. 6 is a perspective view of a mounting base and a part of a seat limit assembly;

FIG. 7 is a side sectional view of the base, the mounting base, a part of the seat limit assembly and a base limit assembly;

FIG. 8 is a perspective view of a child safety seat according to the second embodiment of the present application;

FIG. 9A is a perspective view of the child safety seat in another angle, and FIG. 9B is a partial enlarged view of the frame in FIG. 9A;

FIG. 10A is a side sectional view of the child safety seat, and FIG. 10B is a partial enlarged view of the frame in FIG. 10A;

FIG. 11 is a rear view of a child safety seat according to the third embodiment of the present application;

FIG. 12 is a perspective view of the child safety seat, wherein the seat and the base strut are shown in an engaged state;

FIG. 13 is a perspective view of the child safety seat, wherein the seat and the base strut are shown in a disengaged state;

FIG. 14A is a side sectional view of the child safety seat, wherein the body connection portion is located outside the vertical part of the seat limit assembly, and FIG. 14B is a partial enlarged view of the frame in FIG. 14A;

FIG. 15A is a side sectional view of the child safety seat, wherein the body connection part is located inside the vertical part of the seat limit assembly, and FIG. 15B is a partial enlarged view of the frame in FIG. 15A;

FIG. 16A is a perspective view of the child safety seat, wherein a part of the seat body is removed to show the body connection portion, and FIG. 16B is a partial enlarged view of the frame in FIG. 16A;

FIG. 17 is a side view of the child safety seat with a part of the base being removed;

FIG. 18 is a partial enlarged view of the body connection portion of the child safety seat according to the fourth embodiment of the present application;

FIG. 19A is a side view of a child safety seat according to the fifth embodiment of the present application, wherein the seat body is in a substantially upright position, and wherein a part of the seat body is removed to show the first engagement hook and the second snap hook, and FIG. 19B is a partial enlarged view of the frame in FIG. 19A;

FIG. 20A is a side view of a child safety seat according to the fifth embodiment of the present application, wherein the seat body is in a substantially supine position, and wherein a part of the seat body is removed to show the first engagement hook and the second engaging hook, and FIG. 20B is a partial enlarged view of the frame in FIG. 20A.

### LIST OF REFERENCE NUMBERS

1 Seat
   100 Seat Body
      110 Bottom Portion
      120 Backrest Portion
         121 Slot
      130 Pitch Adjustment Path
         131 Longitudinal Curve
         132 Forwardly Inclined Vertical Curve
      140 Seat Slide Bar
      150 Backrest Frame
   200 Mounting Base
      210 Vertical Axis
      220 Mounting Base Slide Slot Component
   300 Seat Limit Assembly
      310 First engagement hook
         309 Engagement portion
         311 Bending Portion
         312 First Vertical Wall
         313 Second Vertical Wall
         314 Bottom Wall
         315 Open Top Side
         316 First Longitudinal Wall
         317 Second Longitudinal Wall
         318 Rear Wall
         319 Open Front Side
      320 Hook-Shaped Portion
         321 Longitudinal Extension
         322 Vertical Extension
      330 Seat Limit Assembly Vertical Portion
         331 Vertical Portion Hole
      350 Body Connection Portion
      351 Cross Bar
      352 Connecting Lever
         352a Extension Hole
      353 Slide Bar
      354 Slide Slot Component
      360 Anti-Collision Buffer
2 Base
   400 Base Limit Assembly
      410 Second Snap Hook
         411 Third Vertical Wall
         412 Top Wall
         413 Third Longitudinal Wall
         414 Fourth Longitudinal Wall
         415 End Wall
      420 Stiffener
   500 Strut
      510 Strut Vertical Portion
      520 Strut Transverse Portion

### DETAILED DESCRIPTION

Although the invention is illustrated and described herein with reference to particular embodiments, the invention should not be limited to the details shown. Rather, various modifications may be made to these details, within the scope of equivalents of the claims and without departing from the invention.

The descriptions of direction such as “front”, “rear”, “upper”, “lower” and the like involved herein are only for convenience of understanding, and the invention is not limited to these directions, but can be adjusted according to the actual situation. Although the present application has been described with reference to the enumeration of typical embodiments, the terms used are illustrative and exemplary, rather than limiting.

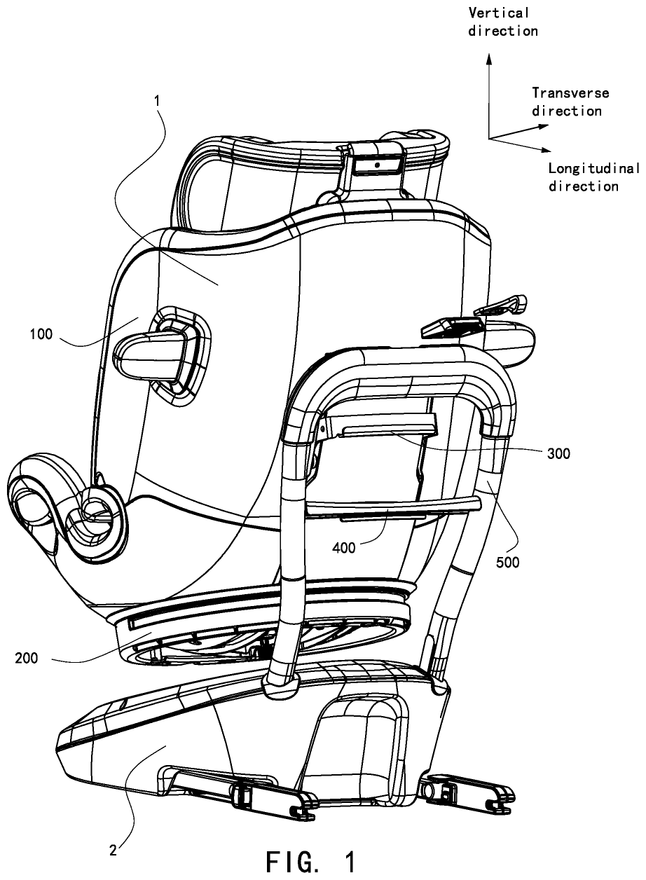

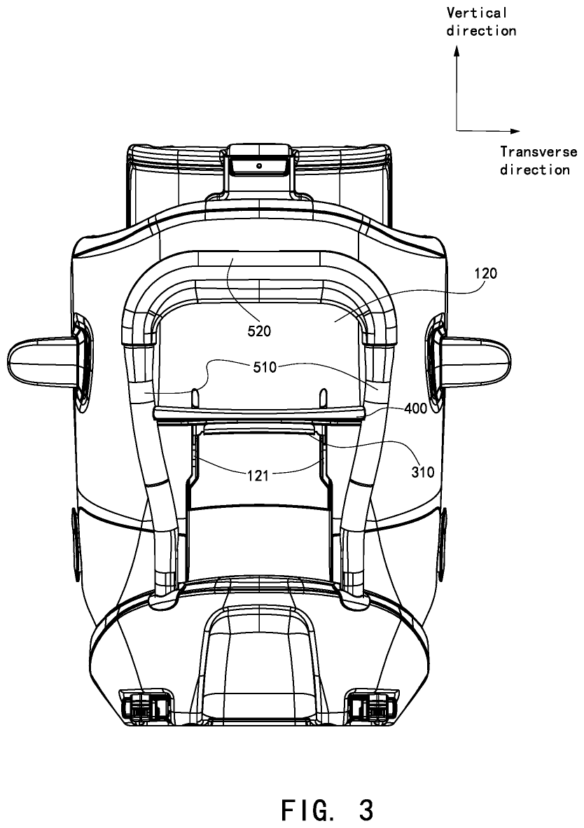

First, a child safety seat according to the first embodiment of the present application will be generally described with reference to FIGS. 1 to 4A.

The child safety seat includes a base 2 and a seat 1. The seat 1 is provided above the base 2, and is the part for a child to seat. Further, the seat 1 includes a seat body 100, a mounting base 200 and a seat limit assembly 300. The base 2 is configured to mount the child safety seat to a vehicle, for example, to a car. A base limit assembly 400, which cooperates with the seat limit assembly 300 on the seat 1 to limit longitudinal movement of the seat 1, is provided on the base 2.

For convenience of understanding the present application by those skilled in the art, the part of seat limit assembly 300 engaged to base limit assembly 400 is collectively referred to as a first engagement portion herein, specifically a first engagement hook 310 in this embodiment; the part of base limit assembly 400 engaged to the seat limit assembly is collectively referred to as a second engagement portion, specifically a second snap hook 410 in this embodiment. In addition, components in the various embodiments of the present application are interchangeable. For example, the first engagement portion and the second engagement portion of the first embodiment may be applied to the third embodiment, and the first engagement portion and the second engagement portion of the second embodiment may also alternatively be applied to the third embodiment.

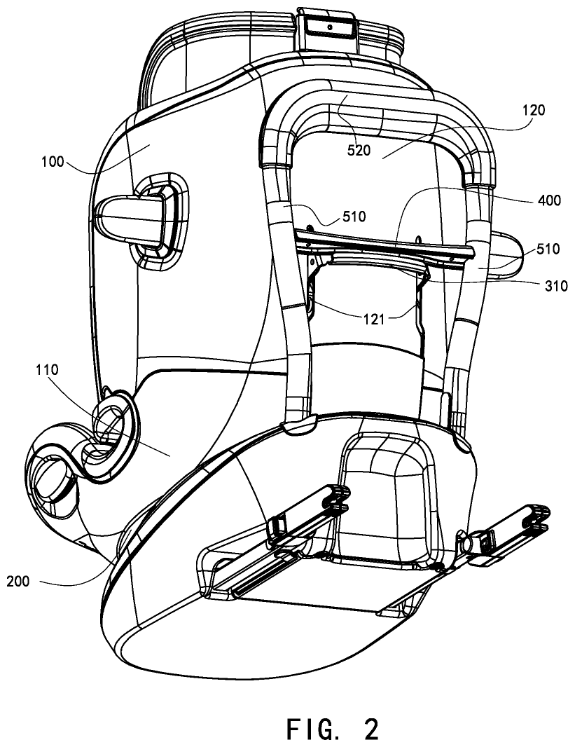

As shown in FIG. 2, the base limit assembly 400 includes the second engagement portion. The strut 500 is substantially U-shaped, and its two strut vertical portions 510 are transversely symmetrically provided relative to the base 2, and extend upward from the longitudinal rear edge of the base 2, and the strut transverse portion 520 is connected between top ends of the strut vertical portions 510. The second engagement portion part is provided between the two struts 500, and when the seat body 100 is rotated to a limit angle, the second engagement portion is engaged to the seat limit assembly 300. A vertical slot 121 is opened up on the backrest portion 120 of the seat body 100, and the seat limit assembly 300 is provided inside the seat body 100 and extends from the inside of the seat body 100 to rear of the seat 1 through the slot 121. The slot 121 further allows relative movement between the seat limit assembly 300 and the seat body 100.

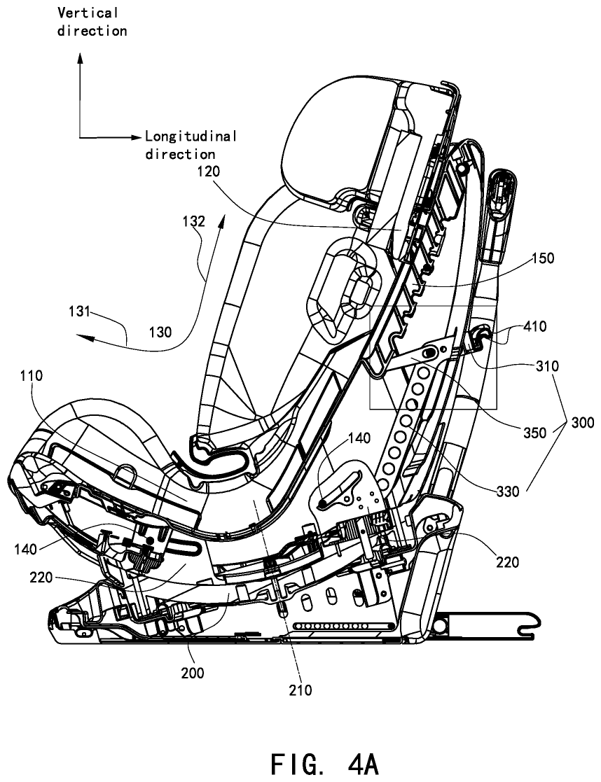

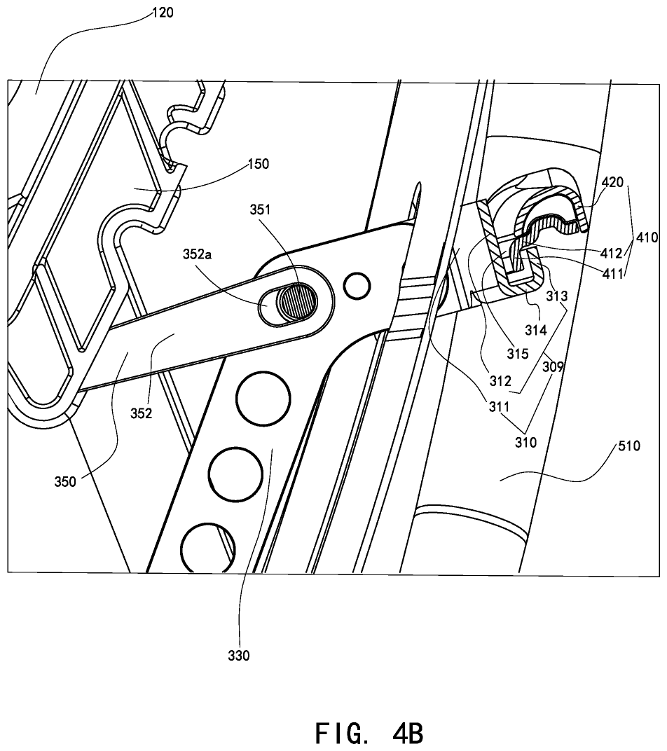

As shown in FIGS. 1 and 4A, the seat body 100 can move relative to the mounting base 200 along a pitch adjustment path 130. FIG. 4A schematically rather than restrictively shows the pitch adjustment path 130, only for understanding of the positional relationship between the seat body 100 and the mounting base 200 and the positional relationship between the seat body 100 and the seat limit assembly 300 by those skilled in the art. In the embodiment shown in FIG. 4A, the pitch adjustment path 130 includes substantively back-and-forth movement of the bottom portion 110 of the seat 1 along a longitudinal curve 131 and substantively up-and-down movement of the backrest portion 120 of the seat 1 along a forwardly inclined vertical curve 132.

A seat slide bar 140 extending transversely is provided below the seat body 100, and mounting base slide slots 220 in pairs are provided above the mounting seat 200. Each seat slide bar 140 is provided in a pair of mounting base slide slots 220 to allow the seat body 100 to move relative to the mounting base 200 along the pitch adjustment path 130. A control mechanism configured to limit or allow the movement of seat body 100 is also provided on the seat body 100 and/or the mounting base 200, which is not elaborated here. It should be understood that, a seat limit assembly vertical portion 330 of the seat limit assembly 300 is provided on the mounting base 200 and substantively does not move together with the seat body 100, see FIGS. 4A, 5A and 6.

In one embodiment, the mount base 200 is a rotary seat that additionally provides a rotation function of the seat body 100. The mounting seat 200 is substantively disc-shaped, and is provided above the base 2 in a manner of allowing the seat 1 to rotate relative to the base 2 around a substantially vertical axis 210. The substantially vertical axis 210 may have a slightly forward angle. The seat body 100 is provided above the mounting base 200 and can rotate relative to the mounting base 200 along the pitch adjustment path 130. The seat body 100 rotates around the vertical axis 210 together with the mounting base 200, therefore the seat 1 has a forward position where the backrest 120 is backward and a rearward position where the backrest 120 is forward. In the forward position, the backrest portion 120 of the seat 1 is close to the rear side of the base 2, and in the rearward position, the backrest portion 120 of the seat 1 is close to the front side of the base 2.

The seat limit assembly 300 is provided on the mounting seat 200 and connected to the seat body 100. More specifically, the seat limit assembly vertical portion 330 of the seat limit assembly 300 is provided to the slide slot component 220 of the mounting base 200. For example, in this embodiment, the mounting base 200 has two sets of slide slot components 220. Two seat limit assembly vertical portions 330 are respectively provided to the longitudinal rear of the mounting base 200, for example, respectively provided to each slide slot component 220 in a set of slide slot components 220 positioned at the longitudinal rear, see FIGS. 4A, 5A and 6. The base limit assembly 400 and the seat limit assembly 300 are provided such that when the seat body 100 is rotated to a limit angle relative to the mounting base 200, the base limit component 400 is engaged to the seat limit component 300 to limit the longitudinal movement of the seat body 100 along the back-and-forth direction.

In this embodiment, the limit angle corresponds to the forward position of the seat 1, that is, the backrest portion 120 is located at a rear location. In other embodiments, according to specific requirements, the limit angle may correspond another position of the seat 1, for example, a rearward position or a transverse position.

The seat limit assembly 300 and the base limit assembly 400 of the first embodiment will be specifically described now with reference to FIGS. 4B to 7.

The seat limit assembly 300 includes the seat limit assembly vertical portion 330, the first engagement portion (in the form of the first engagement hook 310 in this embodiment) and a body connection portion 350.

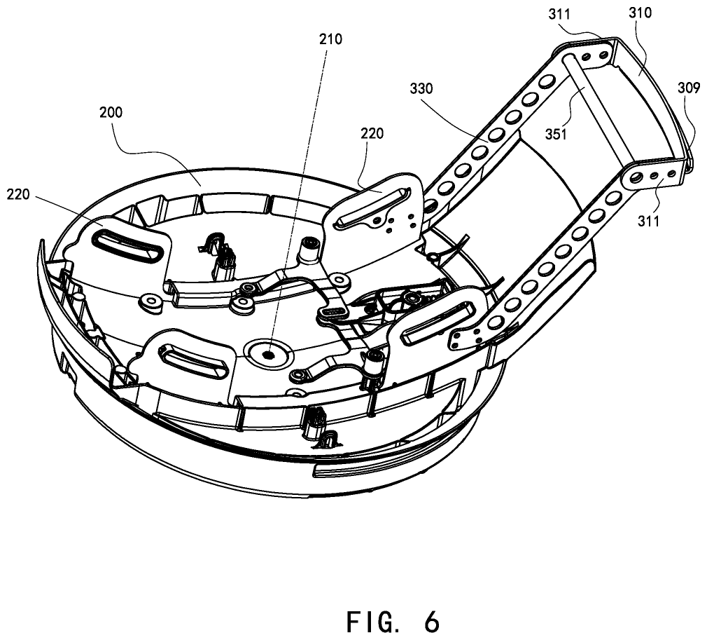

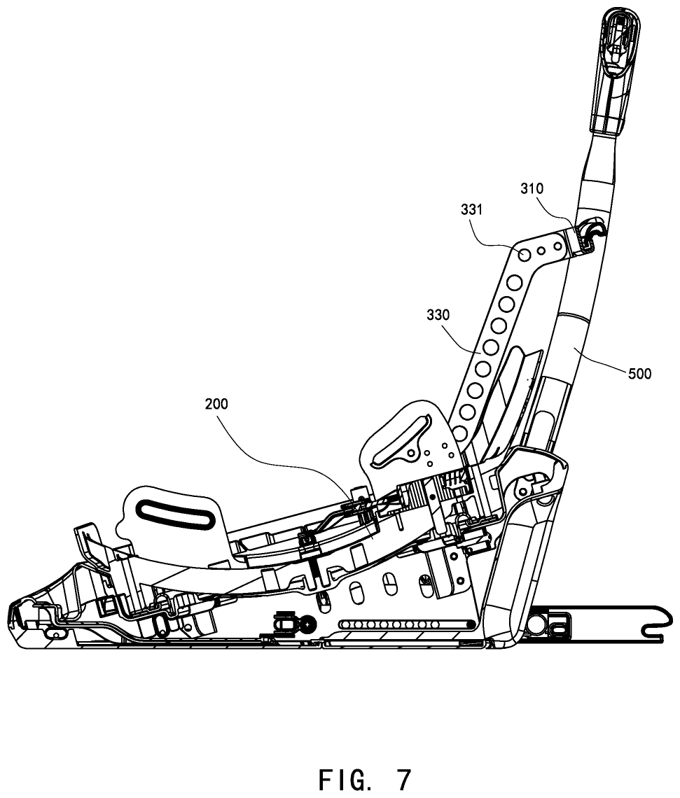

As shown in FIGS. 6 and 7, the seat limit assembly vertical portion 330 is the part that connects the seat limit assembly 300 to the mounting base 200. The seat limit assembly vertical portion 330 extends upward from a circumferential edge of the mounting base 200. In this embodiment, two seat limit assembly vertical portions 330 are lateral symmetrically provided relative to the seat 1 corresponding to circumferential positions of the backrest portions 120 of the seat 1, and extend upward along the seat back part 120. In other embodiments, the seat limit assembly vertical portion 330 can be provided in one or more than two. The seat limit assembly vertical portion 330 can extend slightly backward to make room for the backrest portion 120 of the seat body 100.

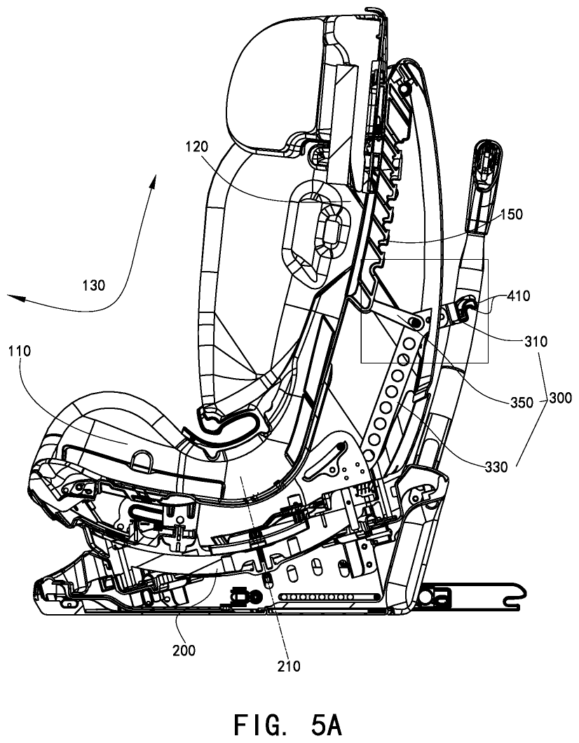

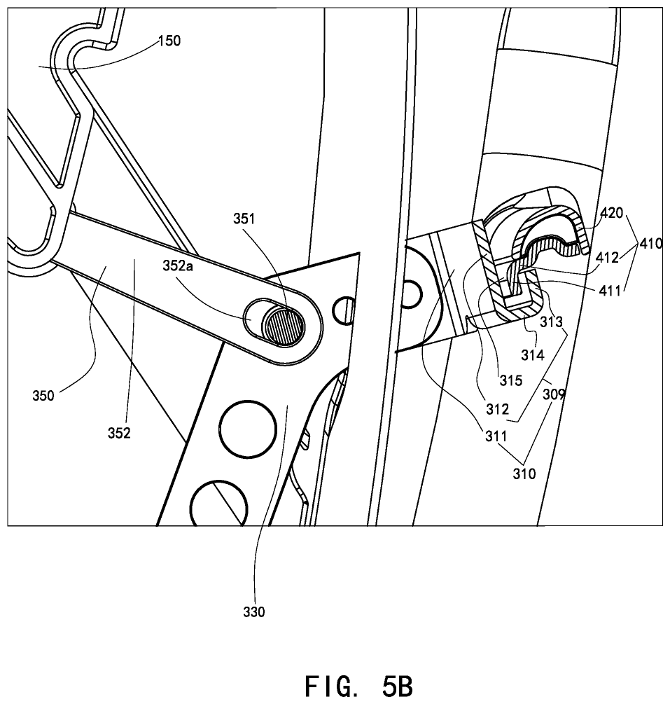

The first engagement portion is the part that engages the seat limit assembly 300 to the base limit assembly 400. In this embodiment, the first engagement portion (i.e., the first engagement hook 310) is engaged to the second snap hook 410 of the seat limit assembly 400, see FIGS. 4A to 5B. The first engagement portion is provided at the upper end of the seat limit assembly vertical portion 330. More specifically, the first engagement portion may extend backward from the upper end of the seat limit assembly vertical portion 330. When the seat body 100 is rotated to the limit angle, the first engagement portion is engaged to the base limit assembly 400. In this embodiment, the first engagement portion includes a first engagement hook 310 transversely provided between two seat limit assembly vertical portions 330. As shown in FIG. 6, the first engagement hook 310 includes a engagement portion 309 and two bending portions 311. The engagement portion 309 extends arcuately in the transverse direction, has a hook-shaped cross-section, and is open at both ends in the transverse direction. More specifically, the center of curvature of the arc of the engagement portion 309 may be located at the vertical axis 210 so that the engagement portion 309 is inserted into the base limit assembly 400 with rotation of the seat 1. Two bending portions 311 respectively extend toward the longitudinal front from both ends of the engagement portion 309 in the transverse direction, and a free end of each bending portion 311 is respectively engaged to the upper end of the corresponding seat limit assembly vertical portion 330.

It should be understood that, in other embodiments, the first engagement hook 310 may be directly formed on the seat limit assembly vertical portion 330. That is, the seat limit assembly vertical portion 330 and the first engagement hook 310 may be formed into one body.

As shown in FIGS. 4B and 5B, the engagement portion 309 has a first vertical wall 312, a second vertical wall 313, a bottom wall 314 and an open top side 315 (i.e., the open part inside the engagement portion 309 opposite to the bottom wall 314). The first vertical wall 312 is connected to the seat limit assembly vertical portion 330 through the bending portion 311, that is, the bending portion 311 extends forward longitudinally from both lateral ends of the first vertical wall 312. The second vertical wall 313 is located behind the first vertical wall 312, the bottom wall 314 is connected between the bottom side of the first vertical wall 312 and the bottom side of the second vertical wall 313, and the open top side 315 is opposite to the bottom wall 314. In this way, when the engagement portion 309 is engaged with the base limit assembly 400, the second vertical wall 313 can abut against the base limit assembly 400 (specifically, the third vertical wall 411) to prevent the seat 1 from moving forward.

The body connection portion 350 is the part that connects the seat limit assembly 300 to the seat body 100 and allows the seat body 100 to move relative to the mount base 200 (i.e., moving along the pitch adjustment path 130). In this embodiment, the body connection portion 350 is pivotally connected to the back frame 150 of the seat body 100. The backrest frame 150 is provided behind the backrest portion 120 of the seat body 100. As shown in FIGS. 4B and 5B, the body connection portion 350 is connected at the top end of the seat limit assembly vertical portion 330 and provided between the back frame 150 of the seat body 100 and the seat limit assembly vertical portion 330. The body connection portion 350 includes a cross bar 351 and a connecting lever 352, the cross bar 351 is transversely provided between two seat limit assembly vertical portions 330, the connecting lever 352 extends in substantially longitudinal direction, and two ends of the connecting lever 352 are pivotally connected to the cross bar 351 and the seat body 100, respectively. FIG. 4B shows the state when the body connection portion 350 corresponds to the seat 1 being in the supine position, and FIG. 5B shows the state when the body connection portion 350 corresponding to the seat 1 being in a vertical position.

The connecting levers 352 are provided corresponding to the number of the seat limit assembly vertical portions 330. In the embodiment provided with two seat limit assembly vertical portions 330, correspondingly, two connecting levers 352 are provided, being respectively connected to the corresponding seat limit assembly vertical portions 330 and respectively connected to the seat body 100. An extension hole 352a extending in the same direction as the connecting lever 352 is provided in each connecting lever 352, and a vertical portion hole 331 is provided at the upper end of each seat limit assembly vertical portion 330 (FIG. 7). The cross bar 351 is provided in the vertical portion hole 331, is provided through the extension hole 352a, and pivotally connected with the connecting lever 352, and the cross bar 351 is movable in the extension hole 352a. More specifically, the cross bar 351 has a sectional shape substantially the same as the shape of the vertical portion hole 331, for example, both are circles with substantially the same diameters. Moreover, the size of the sectional shape of the cross bar 351 is slightly smaller than that of the extension hole 352a. In this way, while the seat body 100 is allowed to move along the pitch adjustment path 130, the seat limit assembly 300 connects the seat body 100 to the base 2 through the connecting lever 352, thereby limiting the movement of the seat body 100 along the longitudinal direction.

As mentioned above, the base limit assembly 400 includes the second engagement portion.

The strut vertical portion 510 of the strut 500 is the part that connects the base limit assembly 400 to the base 2. Two strut vertical portions 510 are lateral symmetrically provided relative to the base 2, and extend upward from the longitudinal rear edge of the base 2. The second engagement portion is provided between the two strut vertical portions 510, and when the seat body 100 is rotated to the limit angle, the second engagement portion is engaged to the first engagement portion of the seat limit assembly 300.

More specifically, in this embodiment, the second engagement portion includes the second snap hook 410 provided between two strut vertical portions 510, and the second snap hook 410 extends in the transverse direction, has a hook-shaped cross-section, and is open at both ends in transverse direction. In one embodiment, the first engagement hook 310 extends transversely in an arc shape around the vertical axis 210 (see FIG. 6), and the second snap hook 410 is also in a substantially same arc shape, so as to engage with the first engagement hook 310 of the seat limit assembly 300 as the seat 1 is rotated. However, it should be understood that, the arc shapes of the first engagement hook 310 and the second snap hook 410 are not necessary, both can also extend along substantially straight in the transverse direction, and a guide structure may be provided at the opening where the first engagement hook 310 and the second snap hook 410 engage, so that the first engagement hook 310 and the second snap hook 410 are engaged smoothly.

In one embodiment, the second snap hook 410 includes a base snap piece and a stiffener 420, the stiffener 420 is transversely provided between two strut vertical portions 510, and the base snap piece is attached to the bottom side of the stiffener 420 and has a hook-shaped cross section to engage to the seat limit assembly 300. In other embodiments, the base snap piece may be omitted, and the hook-shaped cross section is directly formed of the stiffener 420.

As shown in FIGS. 4B and 5B, the second snap hook 410 has a third vertical wall 411 and a top wall 412, wherein the top wall 412 is connected to the strut vertical portion 510, and the third vertical wall 411 extends downward from the front end of the top wall 412. The third vertical wall 411 is engaged with the seat limit assembly 300 (specifically, the second vertical wall 313) to prevent the seat 1 from moving forward.

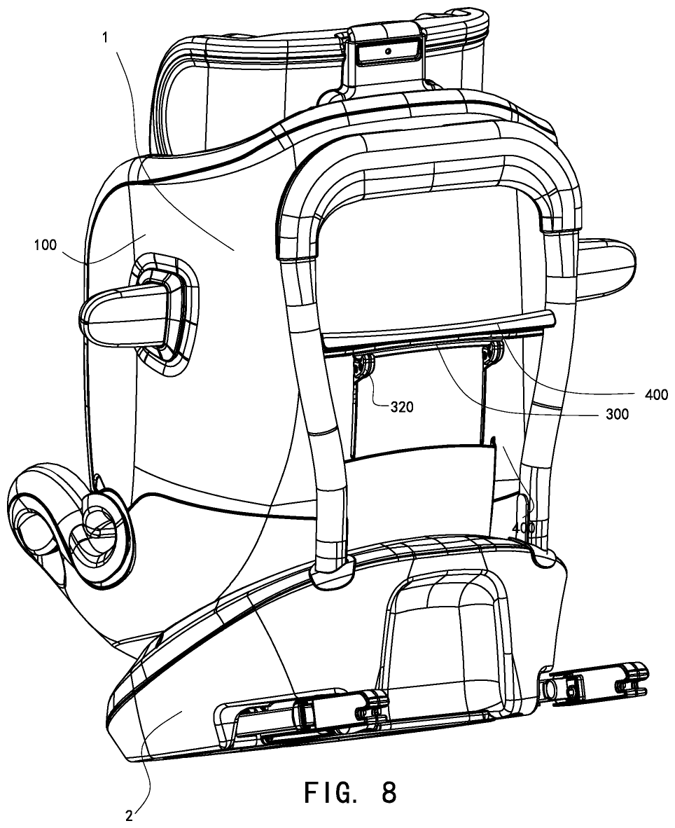

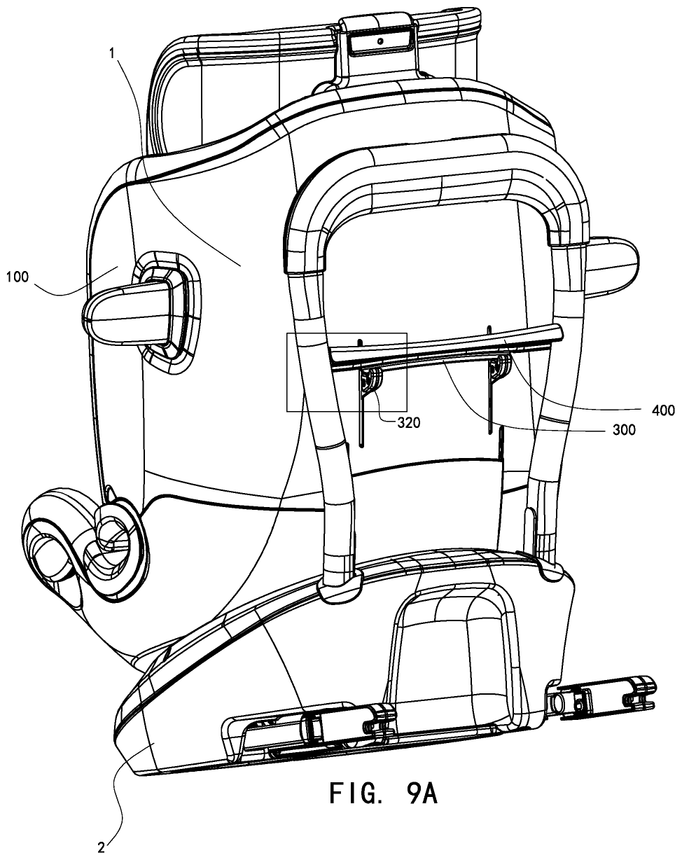

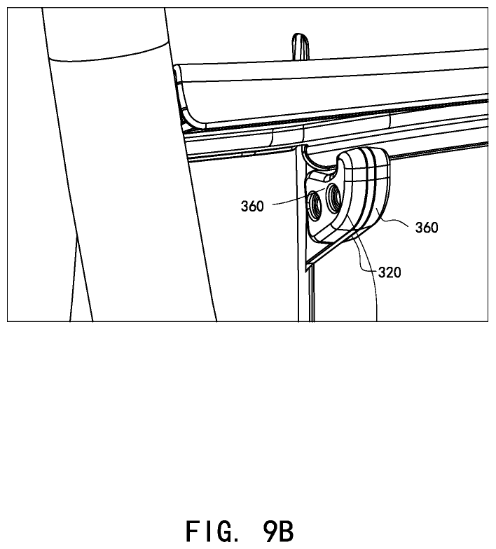

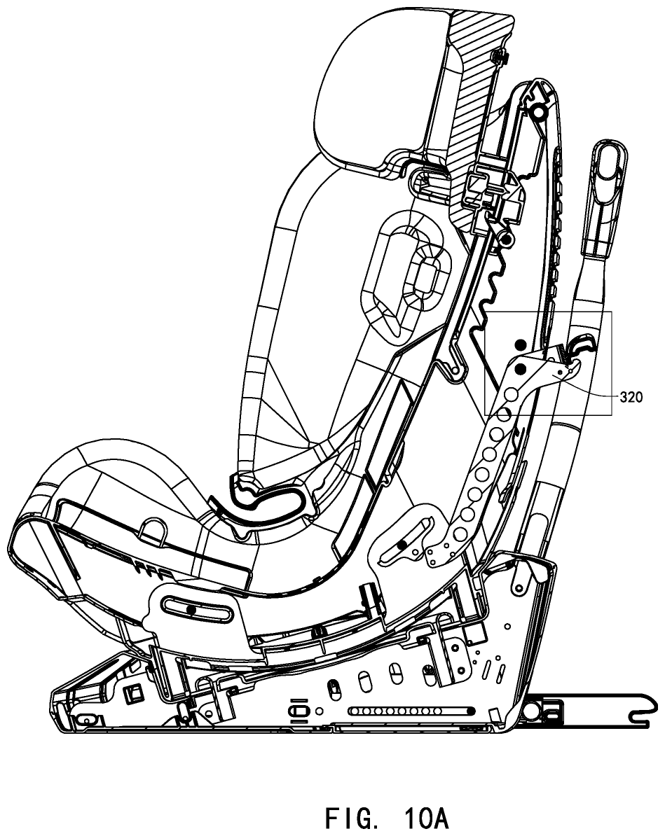

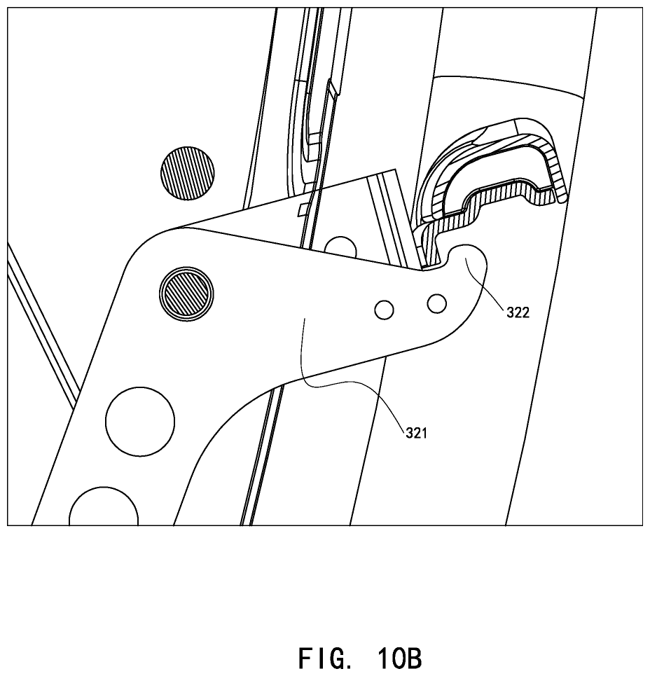

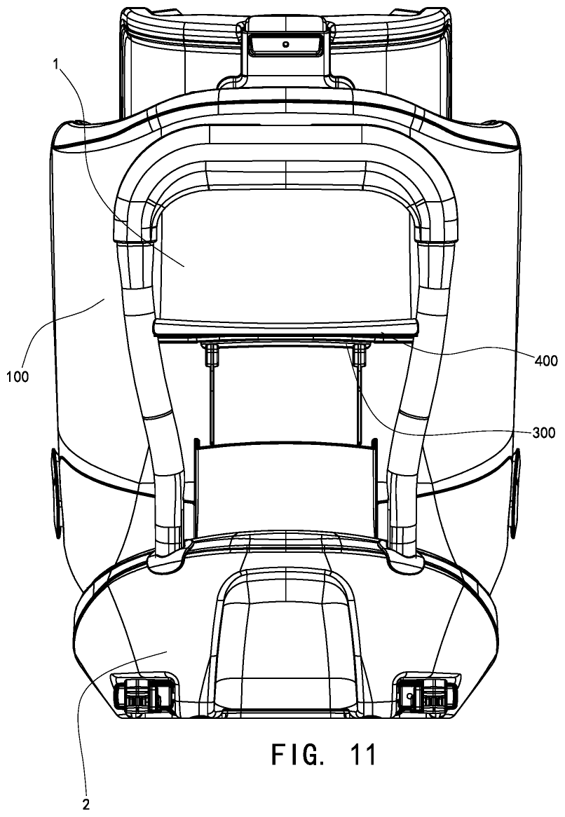

The second embodiment of the child safety seat according to the present application will now be described with reference to FIGS. 8 to 10B.

The second embodiment differs from the first embodiment in that the first engagement hook 310 has a different form.

In this embodiment, the first engagement portion includes a hook-shaped portion 320, and the hook-shaped portion 320 extends in a hook shape from the upper end of the seat limit assembly vertical portion 330 to snap the base limiting assembly 400. The hook-shaped portion 320 includes a longitudinal extension 321 extending backward from the upper end of seat limit assembly vertical portion 330, and a vertical extension 322 extending upward from the rear end of the longitudinal extension 321, and the vertical extension 322 is engaged to the base limit assembly 400 to limit the forward movement of the seat 1.

In this embodiment, the hook-shaped portion 320 and the seat limit assembly vertical portion 330 are integrally formed plates. The seat limit assembly 300 further includes an anti-collision buffer 360, the anti-collision buffer 360 is attached to both sides of the hook-shaped portion 320 in transverse direction and has a substantially same outer contour shape as the hook-shaped portion 320. However, the anti-collision buffer 360 is not necessary, and in other embodiments, the anti-collision buffer 360 may not be provided.

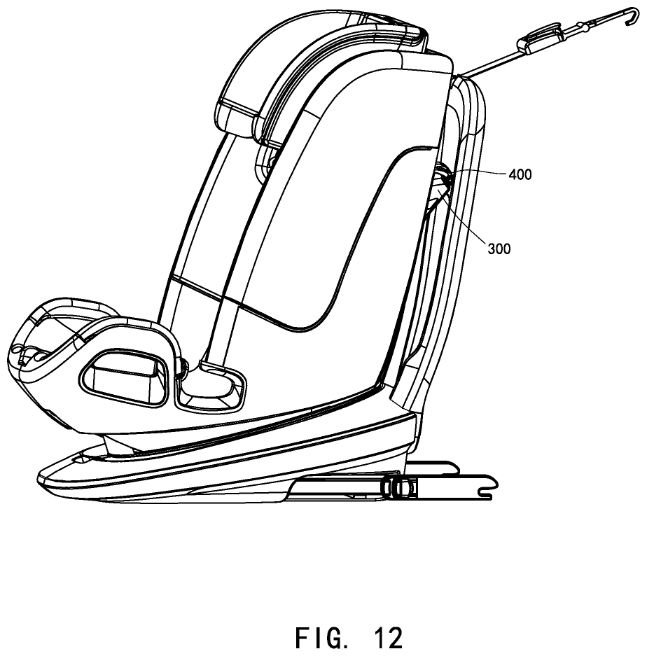

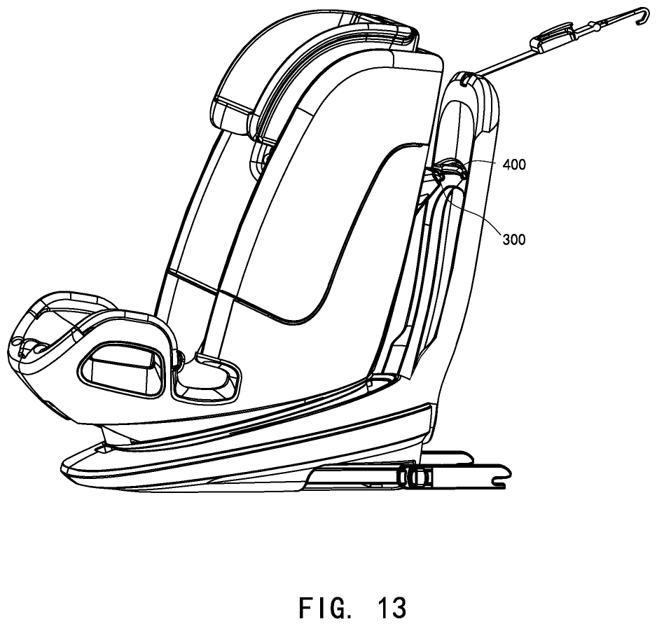

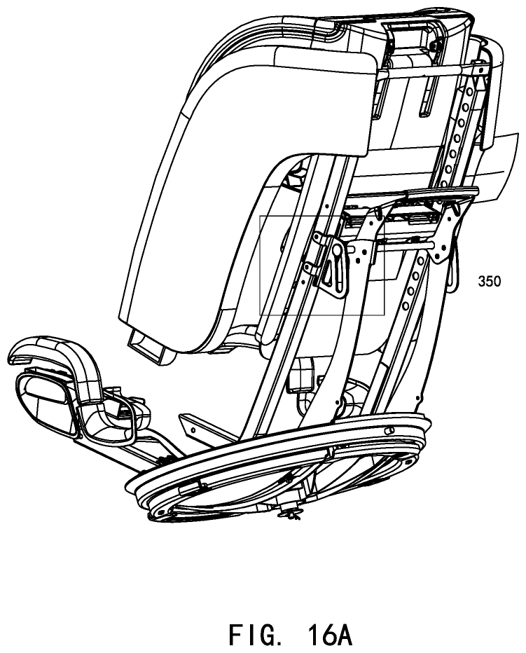

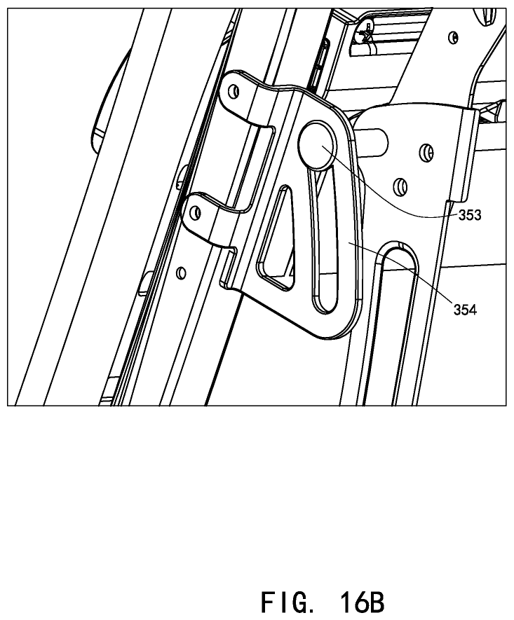

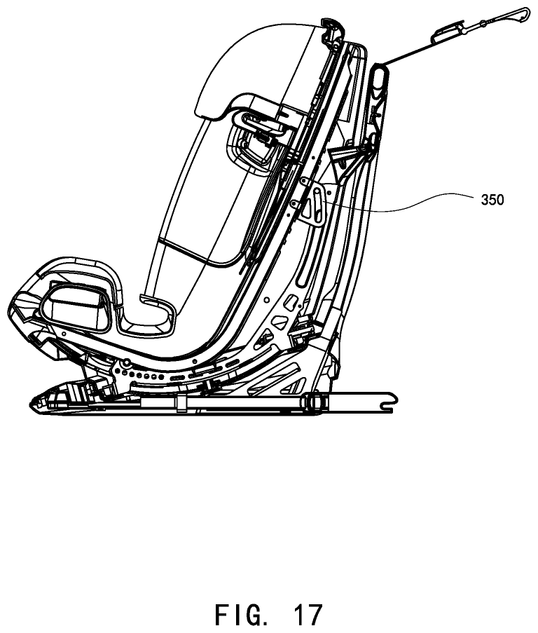

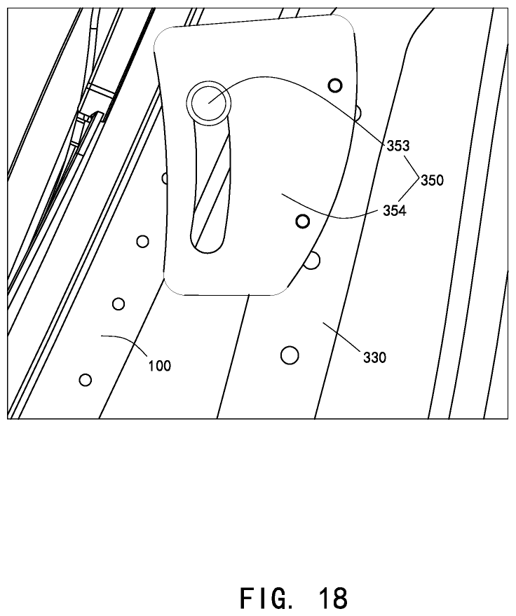

The child safety seat according to the third embodiment of the present application will now be described with reference to FIGS. 11 to 17.

The third embodiment differs from the first embodiment in that the body connection portion 350 has a different form. In the third embodiment, the body connection portion 350 includes a slide bar 353 and a slide slot component 354 having a substantially vertical slide slot. The slide bar 353 is provided on the seat limit assembly vertical portion 330, and the slide slot component 354 is provided on the backrest frame 150 of the seat body 100. More specifically, the slide bar 353 is provided between two seat limit assembly vertical portions 330. The slide slot component 354 is an orifice plate having a slide slot, and the extending direction of the slide slot matches the pitch adjustment path 130 of the seat body 100. In this way, the slide bar 353 is provided passing through the slide slot component 354, and when the seat body 100 is pitched, the slide bar 353 can move in the slide slot component 354 relative to the slide slot component 354 as the seat body 100 moves relative to the mounting base 200 along the predetermined pitch adjustment path 130.

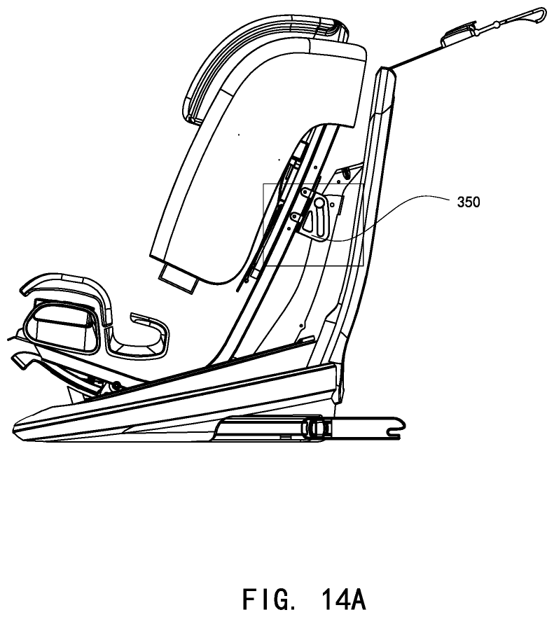

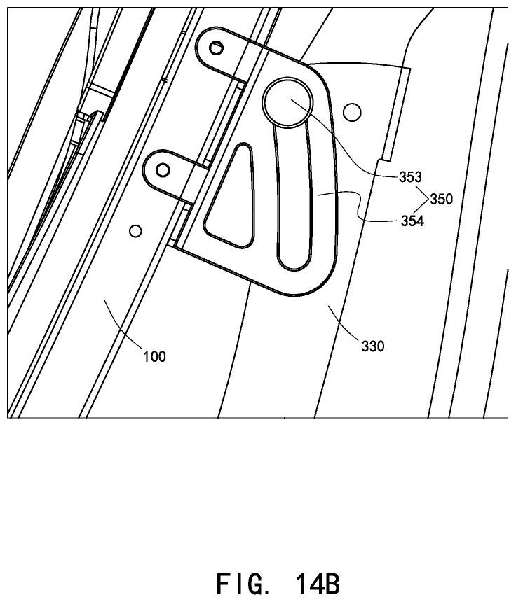

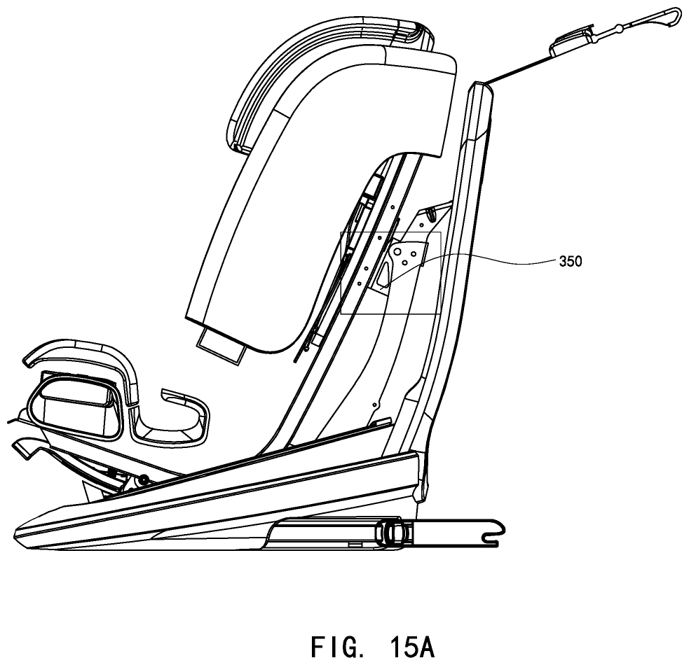

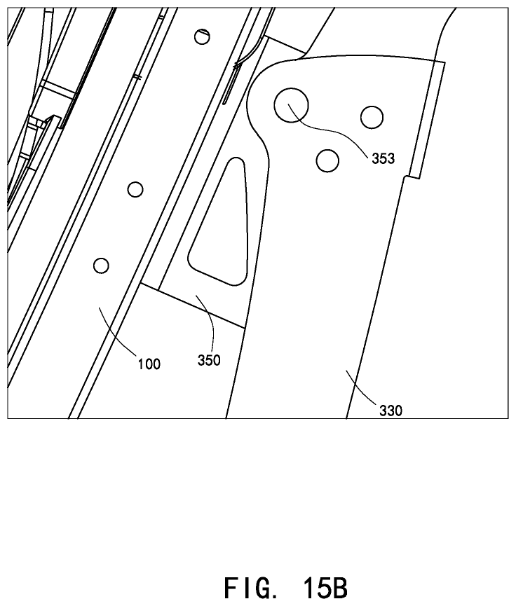

The slide slot component 354 may be provided outside the seat limit assembly vertical portion 330 (see FIG. 14B), or may be provided inside the seat limit assembly vertical portion 330 (see FIG. 15B). In FIGS. 14B and 15B, the slide slot component 354 is provided as a separate component and is provided to the rear portion of the seat body 100.

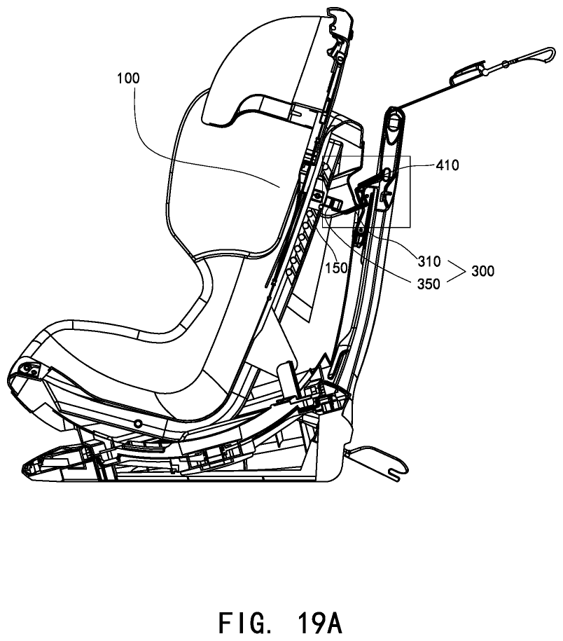

The fourth embodiment of the child safety seat according to the present application will now be described with reference to FIG. 18.

The fourth embodiment is substantially the same as the third embodiment. The difference between the two lies in that, in the fourth embodiment, the slide slot component 354 is provided on the seat limit assembly vertical portion 330, and the slide bar 353 is provided on the seat body 100. Similarly, the slide slot component 354 may also be omitted, so the slide slot is directly opened on the seat limit assembly vertical portion 330.

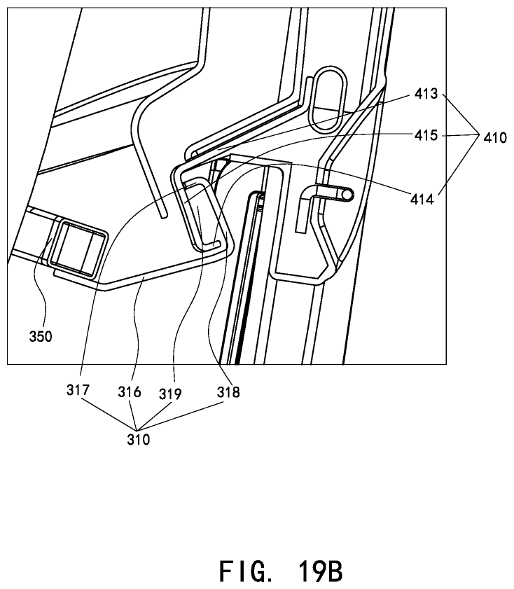

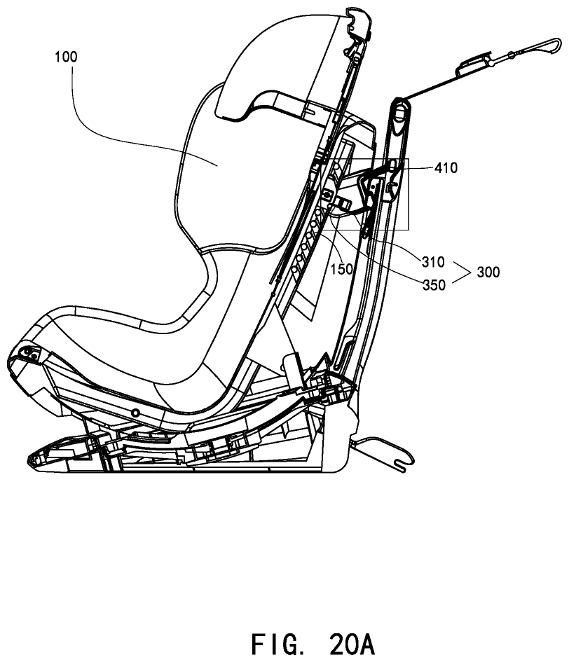

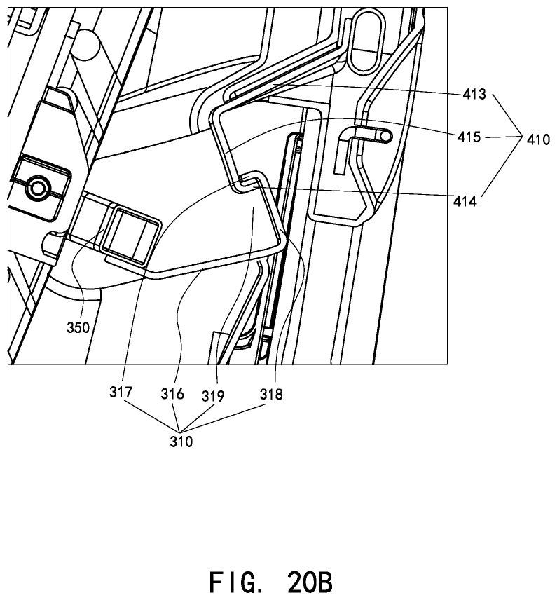

The fifth embodiment of the child safety seat according to the present application will now be described with reference to FIGS. 19A to 20B.

In the fifth embodiment, the seat limit assembly 300 includes the first engagement portion (specifically, the first engagement hook 310) and the body connecting portion 350, and does not necessarily include the seat limit assembly vertical portion 330. The body connection portion 350 connects the seat limit assembly 300 to the backrest frame 150 of the seat body 100 (i.e., the first engagement hook 310 is connected to the backrest portion 150 of the seat body 100), rather than allowing relative movement between the seat body 100 and the seat limit assembly 300 as in the first to fourth embodiments. The body connection portion 350 may be connected to the backrest frame 150 adopting a common connection, so its specific description is omitted. Accordingly, in this embodiment, relative vertical movement between the first engagement portion and the second engagement portion is allowed.

The first engagement hook 310 of the seat limit assembly 300 and the second snap hook 410 of the base limit assembly 400 engage each other, so that the first engagement portion and the base limit assembly 400 can move relative to each other as the seat body 100 moves relative to the mounting base 200 along the predetermined pitch adjustment path 130. That is, the first engagement portion and the second engagement portion can be engaged in the manner of relative vertical movement.

More specifically, the first engagement portion includes the first engagement hook 310 provided between two seat limit assembly vertical portions 330, the first engagement hook 310 extends arcuately in the transverse direction, has a hook-shaped cross section, and is open at both ends in the transverse direction. As shown in FIG. 19B, the first engagement hook 310 has a first longitudinal wall 316, a second longitudinal wall 317, a rear wall 318 and an open front side 319 when viewed in the transverse direction. The first longitudinal wall 316 is connected to the seat body 100, the second longitudinal wall 317 is located above the first longitudinal wall 316, the rear wall 318 is connected between the rear side of the first longitudinal wall 316 and the rear side of the second longitudinal wall 317, and the open front side 319 is opposite to the rear wall 318 and faces the seat body 100. The first engagement hook 310 can move relative to the base limit assembly 400 within a travel range, and prevent the seat 1 from moving forward by the rear wall 318 abutting against the base limit assembly 400.

Correspondingly, the second engagement portion includes the second snap hook 410 provided between two strut vertical portions 510. The second snap hook 410 has a third longitudinal wall 413, a fourth longitudinal wall 414 and an end wall 415 when viewed in the transverse direction, wherein the third longitudinal wall 413 is connected to the strut vertical portion 510, the fourth longitudinal wall 414 is located below the third longitudinal wall 413, and the end wall 415 is connected between the front side of the third longitudinal wall 413 and the front side of the fourth longitudinal wall 414. The second snap hook 410 can move relative to the seat limit assembly 300 within a travel range, and the fourth longitudinal wall 414 abuts against the seat limit assembly 300 to prevent the seat 1 from moving forward.

More specifically, the rear wall 318 of the first engagement hook 310 can abut against the fourth longitudinal wall 414 of the second snap hook 410, and the second longitudinal wall 317 of the first engagement hook 310 can abut against the end wall 415 of the second snap hook 410, thereby preventing the seat 1 from moving forward relative to the base 2.

In summary, the present application provides a child safety seat that can engage the seat body onto the base while allowing the seat body to move for pitch adjustment. In this way, when the vehicle collides, the forward movement of the seat body relative to the base can be limited, thereby improving the safety performance. Further, the present application can also allow the seat body to be rotated between the forward position and the rearward position. According to the inventor's research, when the vehicle collides, the seat body may move forward relative to the base, resulting in a large displacement of the child's head. According to the connection mechanism in the present application, the movement of the seat body relative to the base can be limited, improving the safety performance of the child safety seat.

Since the application can be embodied in various forms without departing from the spirit and essence of the present application, it should be understood that, the foregoing embodiments are not limited to any foregoing details, but should be construed in the broadest sense as defined by the claims, and all changes that falls into the scope of the claims or their equivalents are therefore should be covered by the claims.

1. A child safety seat comprising:
a base, comprising a base limit assembly; and
a seat, provided above the base and comprising:
a mounting base provided above the base;
a seat body provided above the mounting base, and is movable relative to the mounting base along a pitch adjustment path; and
a seat limit assembly provided on the seat and connected to the seat body;
wherein the base limit assembly is engaged with the seat limit assembly to limit a longitudinal movement of the seat body.

2. The child safety seat according to claim 1, wherein
the mounting base is a rotary seat provided above the base in a manner that the seat is rotatable relative to the base around a substantially vertical axis;
wherein the base limit assembly and the seat limit assembly are configured such that when the seat body is rotated to a forward position, the base limit assembly is engaged with the seat limit assembly to limit the longitudinal movement of the seat body in a substantially back-and-forth direction.

3. The child safety seat according to claim 2, wherein
the base limit assembly is provide at a longitudinal rear edge of the base.

4. The child safety seat according to claim 2, wherein
the seat is rotated relative to the base between a forward position and a rearward position, in the forward position, a backrest portion of the seat is close to a rear side of the base, and in the rearward position, the backrest portion of the seat is close to a front side of the base; and
the pitch adjustment path comprises a substantial back-and-forth movement of a bottom portion of the seat along a longitudinal curve and a substantial up-and-down movement of the backrest portion of the seat along a forwardly inclined vertical curve.

5. The child safety seat according to claim 1, wherein
the seat limit assembly comprises:
a seat limit assembly vertical portion extending upward from a circumferential edge of the mounting base;
a first engagement portion provided at an upper end of the seat limit assembly vertical portion, wherein when the seat body is rotated to a limit angle, the first engagement portion is engaged with the base limit assembly; and
a body connection portion connected between the seat body and the seat limit assembly vertical portion.

6. The child safety seat according to claim 5, wherein
the seat limit assembly vertical portions are provided in two and transversely symmetrically provided relative to the seat corresponding to circumferential positions of the backrest portions of the seat, and extend upward along the backrest portion; and the body connection portions are provided in two and respectively connected with corresponding seat limit assembly vertical portions.

7. The child safety seat according to claim 6, wherein
the first engagement portion comprises a first engagement hook transversely provided between the two seat limit assembly vertical portions, and the first engagement hook comprises a engagement portion which is transversely extended, has a hook-shaped cross section, and is open at both ends in a transverse direction.

8. The child safety seat according to claim 7, wherein
the first engagement hook further comprises two bending portions respectively extending forward longitudinally from both ends of the engagement portion in a transverse direction, and a free end of each bending portion is respectively engaged to an upper end of a corresponding seat limit assembly vertical portion.

9. (canceled)

10. The child safety seat according to claim 6, wherein
the body connection portion comprises a cross bar and a connecting lever, the cross bar is transversely provided between two seat limit assembly vertical portions, the connecting lever extends in a substantively longitudinal direction, and both ends of the connecting lever are pivotally connected to the cross bar and the seat body, respectively.

11. The child safety seat according to claim 10, wherein
the connecting levers are provide in two, an extension hole extending in a same direction as the connecting lever is provided in each connecting lever, the cross bar is provided passing through the extension hole, and pivotally connected with the connecting lever, and the cross bar is moveable in the extension hole relative to the extension hole.

12. The child safety seat according to claim 6, wherein
the first engagement portion comprises a hook-shaped portion extending in a hook shape from an upper end of the seat limit assembly vertical portion to engage with the base limit assembly.

13. The child safety seat according to claim 12, wherein
the hook-shaped portion comprises a longitudinal extension extending backward from the upper end of the seat limit assembly vertical portion and a vertical extension extending upward from a rear end of the longitudinal extension, and the vertical extension is engaged with to the base limit assembly to limit a forward movement of the seat.

14. (canceled)

15. The child safety seat according to claim 6, wherein
the body connection portion comprises a slide bar and a slide slot component having an elongated slide slot, the slide bar is provided at one of the seat body and the seat limit assembly vertical portion, and the slide slot component is provided at the other of the seat body and the seat limit assembly vertical portion; and
the slide bar is provided passing through the slide slot component, and the slide bar is moveable in the slide slot component relative to the slide slot component as the seat body is rotated relative to the mounting base along the pitch adjustment path.

16. The child safety seat according to claim 6, wherein
the seat limit assembly is connected to the seat body by the body connection portion; and
the first engagement portion and the base limit assembly are engaged with each other such that the first engagement portion and the base limit assembly are moveable relative to each other as the seat body moves relative to the mounting base along the pitch adjustment path.

17. The child safety seat according to claim 16, wherein
the first engagement portion comprises a first engagement hook provided between two seat limit assembly vertical portions, and the first engagement hook is transversely extended, has a hook-shaped cross section, and is open at both ends in a transverse direction; and
the first engagement hook has a first longitudinal wall, a second longitudinal wall, a rear wall and an open front side, wherein the first longitudinal wall is connected to the seat body, the second longitudinal wall is located above the first longitudinal wall, the rear wall is connected between a rear side of the first longitudinal wall and a rear side of the second longitudinal wall, and the open front side is opposite to the rear wall and faces the seat body;
wherein the first engagement hook is moveable relative to the base limit assembly within a travel range, and prevents the seat from moving forward by the rear wall abutting against the base limit assembly.

18. The child safety seat according to claim 5, wherein
the base comprises:
two strut vertical portions, transversely symmetrically provided relative to the base, and extending upward from a longitudinal rear edge of the base; and
a second engagement portion, provided between two strut vertical portions and engaged to the seat limit assembly.

19. The child safety seat according to claim 18, wherein
the second engagement portion comprises a second snap hook provided between two strut vertical portions, and the second snap hook is transversely extended, has a hook-shaped cross section, and is open at both ends in a transverse direction.

20. The child safety seat according to claim 19, wherein
the second engagement portion further comprises a stiffener transversely provided between the two strut vertical portions; and
the second snap hook is a base engagement piece attached to a bottom side of the stiffener.

21. The child safety seat according to claim 20, wherein
the second snap hook comprises a third vertical wall and a top wall, wherein the top wall is connected to the strut vertical portion, and third vertical wall extends downward from a front end of the top wall;
wherein an engagement between of the third vertical wall and the seat limit assembly prevents the seat from moving forward.

22. (canceled)

23. The child safety seat according to claim 1, wherein
as the seat body moves along the pitch adjustment path, the seat is always engaged with and the base through the seat limit assembly and the base limit assembly, and a relative position between the first engagement portion of the seat limit assembly and the second engagement portion of the base limit assembly is substantively unchanged.
